(19) United States
(12) Patent Application Publication
(10) Pub. No.: US 2010/0232160 A1
(43) Pub. Date: Sep. 16, 2010

(54) ILLUMINATION DEVICE HAVING ADJUSTABLE DISTRIBUTION CURVE OF LUMINOUS INTENSITY

(75) Inventor: CHIH-MING LAI, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/712,212

(22) Filed: Feb. 25, 2010

(30) Foreign Application Priority Data
Mar. 13, 2009 (CN) 200910300871.4

(51) Int. Cl. F21S 8/00

(52) U.S. Cl. 362/277

(57) ABSTRACT

An illumination device includes a light source, an optical film, and a drive module. The optical film has a plurality of optical regions, each having a light incident surface opposite to the light source and a light emitting surface opposite to the light incident surface, and at least one of each of the light incident and emitting surfaces has a micro-structure. The drive module moves the optical film in the space, and light emitted by the light source passes through the different optical regions of the optical film, changing the distribution curve of luminous intensity of the light source.

### BACKGROUND

1. Technical Field

The disclosure relates to an illumination device, and particularly to an illumination device that can change a distribution curve of its luminous intensity.

2. Description of the Related Art

Light emitting diodes' (LEDs) many advantages, such as high luminosity, low operational voltage, low power consumption, compatibility with integrated circuits, easy driving, long term reliability, and environmental friendliness have promoted wide use as a light source.

Joseph Bielecki et al in IEEE,23^{rd} IEEE SEMI-THERM Symposium, “Thermal Considerations for LED Components in an Automotive Lamp.” characterize light emitting diodes as one kind of semiconductor device changing current into light of specific wavelength.

A distribution curve of luminous intensity quantifies light emitted by a light source, which, for a traditional light source is fixed and usually has radial or isotropic characteristics, such that the distribution curve of luminous intensity of an illumination apparatus using the light source generally is decided by optical elements of the apparatus, such as a cover or lens.

FIG. 1 shows the distribution curve of luminous intensity of an LED light source representing Lambertian distribution. As shown, the Full Width at Half Maximum of the light source is within ±60°; accordingly, the Full Width at Half Maximun is 120°.

Changing the distribution curve of luminous intensity of light source requires the primary optical element of the LED or light source, such that the user cannot normally make such a change arbitrarily.

What is needed therefore, is an illumination device to overcome the described limitations.

### BRIEF DESCRIPTION OF THE DRAWINGS

Many aspects of the present illumination device can be better understood with reference to the following drawings. The components in the drawings are not necessarily drawn to scale, the emphasis instead being placed upon clearly illustrating the principles of the present illumination device. Moreover, in the drawing, like reference numerals designate corresponding parts throughout the several views.

FIG. 1 is a schematic view of a distribution curve of luminous intensity of a commonly used light source.

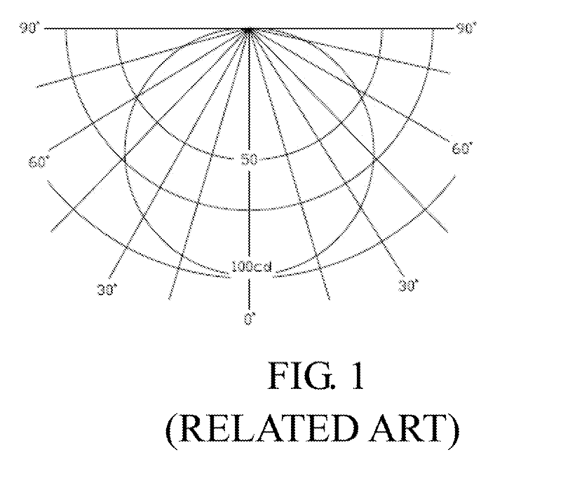

FIG. 2 is a schematic view of an illumination device in accordance with a first embodiment.

FIG. 3 is a partial schematic cross section of optical region 211a in FIG. 2

FIG. 4 is a partial schematic cross section of optical region 211b in FIG. 2

FIG. 5 is a schematic view of a distribution curve of luminous intensity of light passing through region 211a.

FIG. 6 is a schematic view of a distribution curve of luminous intensity of light passing through region 211b.

FIG. 7 is a schematic view of an imprinter creating sawtooth protrusions on optical film.

FIG. 8 is a schematic cross section of sawtooth protrusions of a micro-structure in FIG. 2.

FIG. 9 is a schematic cross section of a light incident surface and light emitting surface, both having micro-structures in FIG. 2.

### DETAILED DESCRIPTION

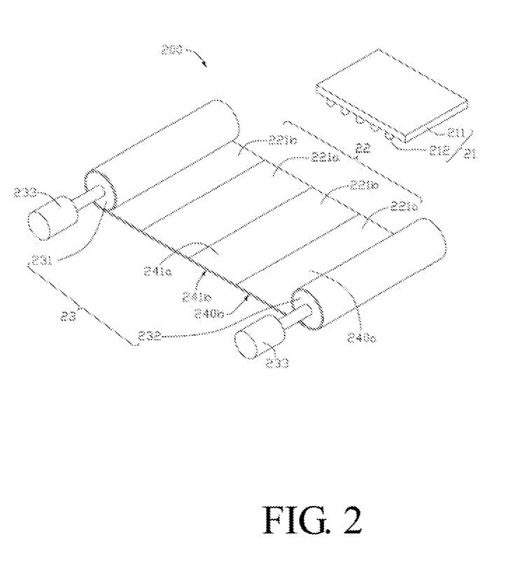

Referring to FIG. 2, an illumination device 200 in accordance with the first embodiment is shown. The illumination device 200 includes a light source 21, an optical film 22, and a drive module 23.

The light source 21 includes a substrate 211 and a plurality of light emitters 212 mounted thereon. The surface, having a plurality of light emitters 212 is the light emitting surface of light source 21. The light emitters 212 can be laser, light emitting diodes, organic light emitting diodes, or light emitting diode modules.

The optical film 22 is mounted on the light emitting surface of the light source21. The optical film 22 is rectangular and flexible, preferably of a thickness of 1 mm or less.

In this embodiment, the optical film 22 includes a plurality of optical regions 221a interlaced with optical regions 221b.

The optical region 221a has a light incident surface 240a opposite to the light source 21 and a light emitting surface 240b opposite to the light incident surface 240a. The optical region 221b has a light incident surface 241a opposite to the light source 21 and a light emitting surface 241b opposite to the light incident surface 241a.

The optical films 22 can be silicone, glass, PMMA (polymethylmethacrylate), PC (polycarbonate), epoxy, or polyethylene terephthalate (PETE).

In this embodiment, the light incident surface 240a of the optical region 221a and the light incident surface 241a of the optical region 221b are smooth planes.

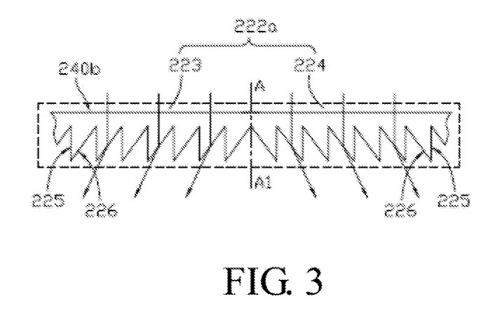

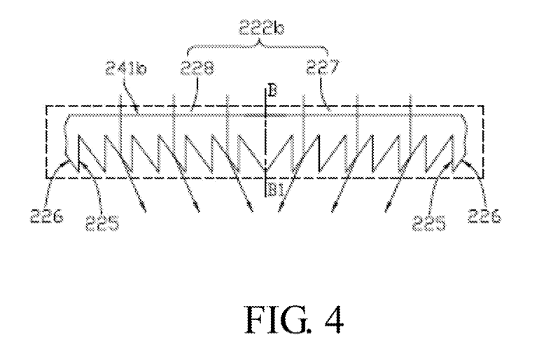

Referring to FIG. 3 and FIG. 4, the light emitting surface 240b of the optical region 221a and the light emitting surface 241b of the optical region 221b respectively and correspondingly provide a micro-structure 222a, 222b.

FIG. 3 is a partial cross section of the light emitting surface 240b having the micro-structure 222a. The micro-structure 222a includes a first micro-structure 223 and a second micro-structure 224. The first micro-structure 223 includes a plurality of sawtooth protrusions, each with a first surface 225 perpendicular to the light emitting surface 240b of the light region 221a and a second surface 226 connecting to the first surface 225, wherein the second surface 226 and the first surface 225 form an acute angle therebetween. The second micro-structure 224 and the first micro-structure 223 are symmetrical about an axis A-A1 between the second and first micro-structures 224, 223.

The second surface 226 of the sawtooth protrusion included in the first micro-structure 223 connects to the second surface 226 of the sawtooth protrusion included in the second micro-structure 224, wherein light emitted by the light source 21 passes through the micro-structure 222a and is scattered.

FIG. 4 is a schematic cross section of a light emitting surface 241b having the micro-structure 222b. The micro-structure 222b includes a third micro-structure 227 and a fourth micro-structure 228. The third micro-structure 227 has the same structure as the first micro-structure 223. The fourth micro-structure 228 and the third micro-structure 227 are symmetrically disposed. Physically, the second surface 226 of the sawtooth protrusions of the third micro-structure 227 is connected to the second surface 226 of the sawtooth protrusions of the fourth micro-structure 228. Light emitted by the light source 21 and passing through micro-structure 222b is focused toward the symmetrical axis B-B1 of the micro structure 222b between the third micro-structure 227 and the fourth micro-structure 228. The two connected second surfaces 226 of the micro structure 222a converge toward the light source 21, while the two connected second surfaces 226 of the micro structure 222b converge away from the light source 21.

The drive module 23 includes a first roller 231, a second roller 232, and a control unit 233. Two ends of the optical film 22 are connected separately to the first roller 231 and the second roller 232. The control unit 233 drives the rollers 231, 232, in this embodiment, by means of a motor.

The first roller 231 and the second roller 232 move the optical film 22 through the space, whereby light from the light source 21 passes through the optical regions 221a, 221b of optical film 22, before being emitted, with passage through the different micro-structures 222a, 222b of optical regions 221a and 221b producing correspondingly altered distribution curves of luminous intensity.

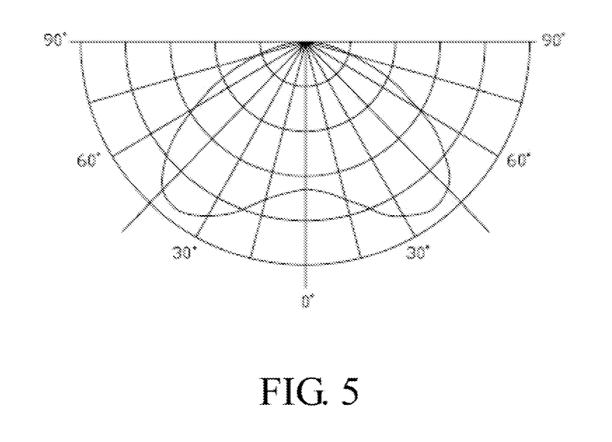

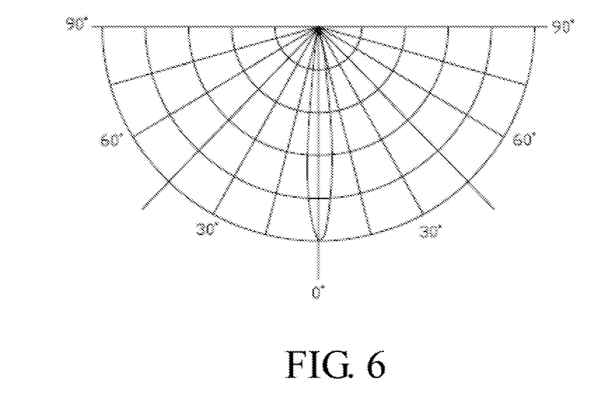

FIG. 5 shows the distribution curve of luminous intensity of the light source 21 passing through the optical region 221a having the micro-structure 222a. FIG. 6 shows the distribution curve of luminous intensity of the light source 21 passing through the optical region 221 having the micro-structure 222b. Light passes through the micro-structure 222b and is refracted along symmetrical axis BB1 of the third micro-structure 227 and fourth micro-structure 228.

The micro-structures of each optical region of the optical film 22 produce correspondingly altered distribution curves of luminous intensity for light passing therethrough. The optical film can be moved in the space, providing a variety of alterations to the distribution curves of luminous intensity of the light source 21.

Periodic length of the micro-structure of the optical film 22 is generally 0.1 um to 1 mm. The micro-structures are generally formed by imprinting or photolithography.

Imprinting generally forms the micro-structures with periodic length of 10 um to 1 mm. A rolling imprinter method is often used. Photolithography generally forms the micro-structures with periodic length of 0.1 um to 1 mm.

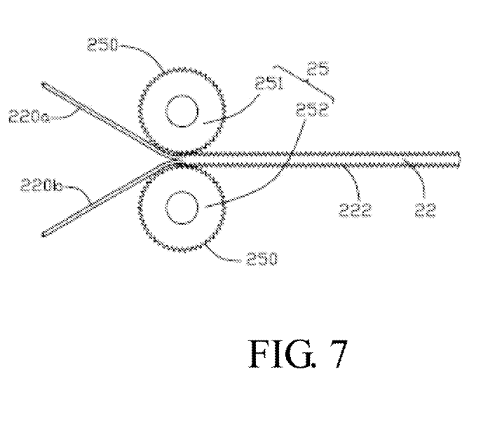

FIG. 7 shows an imprinting method of forming micro-structures separately on a light emitting surface and light incident surface. Here, the first optical film 220a and the second optical film 220b pass through an imprinter apparatus 25 to become the optical film 22, with micro-structures 222 formed on two opposite surfaces thereof.

The rolling imprinter apparatus 25 includes a first roller 251 and a second roller 252. The first optical film 220a and the second optical film 220b are oppositely set between the first roller 251 and the second roller 252. The first roller 251 rotates counterclockwise, and the second roller clockwise, driving the first optical film 220a and the second optical film 220b horizontally to the right, then rolling the first optical film 220a and the second optical film 220b to become the optical film 22. The first roller 251 and the second roller 252 comprise gear wheel 250. Micro-structures corresponding to the shape of gear wheel 250 can be formed. Moreover, changes in the shapes of the first roller 251 and the second roller 252 vary the shape of micro-structure formed thereby.

The optical film 26 can include multiple optical regions thereon, with the shapes thereof not limited to the rectangle described here, and can further be disposed in an array. Protrusions of micro-structures mounted on optical films 22 are not limited to a sawtooth configuration, and can be of other shape, such as curved, convex, cylindrical, concave, or other.

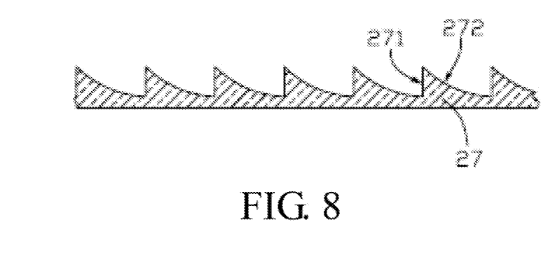

FIG. 8 shows a sawtooth protrusion 27, wherein each sawtooth protrusion 27 includes a first surface 271 connected to a second concave surface 272 thereof.

As can be seen, the micro-structure can be formed on the light incident surface and light emitting surface of the optical film at the same time, with the formed micro-structures different.

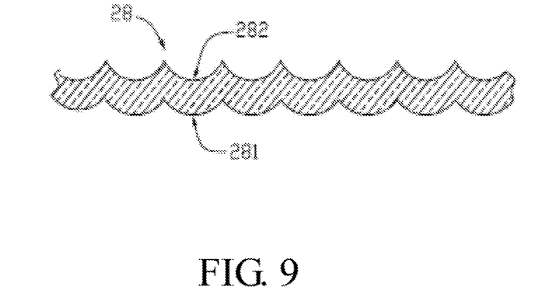

Referring to FIG. 9, the light incident surface and the light emitting surface of optical film 28 respectively include cylindrical protrusions 281 and cylindrical concavities 281, although the micro-structures mounted on the light incident surface or the light emitting surface of optical film 22 can be of other combinations.

While certain embodiments have been described and exemplified above, various other embodiments from the foregoing disclosure will be apparent to these skilled in the art. The disclosure is not limited to the particular embodiments described and exemplified but is capable of considerable variation and modification without departure from the scope of the appended claims.

What is claimed is:

1. An illumination device, comprising:
a light source;
an optical film, the optical film comprising a plurality of optical regions, each optical region comprising a light incident surface opposite to the light source, and a light emitting surface opposite to the light incident surface, wherein at least one of the light incident surface and the light emitting surface of the optical region comprises a micro-structure; and
a drive module moving the optical film relative to the light source and light emitted by the light source passing through the optical film whereby the light can pass through a selected one of the optical regions of the optical film to obtain a correspondingly desired distribution curve of luminous intensity.

2. The illumination device of claim 1, the drive module including a first roller and a second roller, to which the two ends of the optical film are connected separately, wherein rolling of the rollers move the optical film.

3. The illumination device of claim 1, wherein the micro-structure thereof comprises sawtooth protrusions, curved protrusions, cylindrical protrusions, curved concavities, or cylindrical concavities.

4. The illumination device of claim 1, wherein each of the light incident surface and the light emitting surface of each optical region of the optical film comprises the micro-structure.

5. The illumination device of claim 1, wherein the light source is a light emitting diode.

6. The illumination device of claim 1, wherein the material of the optical film is silicone, glass, PMMA, PC, epoxy, or polyethylene terephthalate.

7. The illumination device of claim 1, wherein the optical films is 1 mm or less in thickness.

8. The illumination device of claim 1, wherein the micro-structure of one of the plurality of optical regions includes a first micro-structure and a second-structure symmetrical with the first micro-structure, and the micro-structure is a sawtooth protrusion comprising a first surface perpendicular to the optical film and a second surface connected to and forming acute angle with first surface.

9. The illumination device of claim 8, wherein the second surface of the sawtooth protrusion of the first micro-structure connects to the second surface of the sawtooth protrusion of second micro-structure, and the connected second surfaces converge toward the light source.

10. The illumination device of claim 8, wherein the second surface of the sawtooth protrusion of the first micro-structure thereof connects to the second surface of the sawtooth protrusion of the second micro-structure, and the connected two second surfaces converge away from the light source.
